(19) United States
(12) Patent Application Publication
(10) Pub. No.: US 2013/0257857 A1
(43) Pub. Date: Oct. 3, 2013

(54) STEREOSCOPIC DEVICE AND IMAGE GENERATION METHOD

(71) Applicant: NAMCO BANDAI GAMES INC., Tokyo (JP)

(72) Inventors: Takahiro KAKIZAWA, Yokohama-shi (JP); Masayuki SHIRAKO, Yokohama-shi (JP); Tohru HISANO, Yokohama-shi (JP); Tohru KIKUCHI, Kawasaki-shi (JP); Motonaga ISHII, Tokyo (JP); Shinobu NIMURA, Yokohama-shi (JP)

(73) Assignee: NAMCO BANDAI GAMES INC., Tokyo (JP)

(21) Appl. No.: 13/780,477

(22) Filed: Feb. 28, 2013

(30) Foreign Application Priority Data
Mar. 30, 2012 (JP) 2012-080193

(51) Int. Cl. G06F 3/0481

(52) U.S. Cl. CPC G06F 3/04815
USPC 345/419

(57) ABSTRACT

An image projected onto a screen from a projector is generated as follows. Specifically, two virtual viewpoints that correspond to the right eye and the left eye of a viewer are set in a virtual three-dimensional space, and two virtual planes are set to be circumscribed to the screen (plane of projection). A plane image is generated by perspective projection transformation of a game space onto the virtual plane based on each virtual viewpoint. A projection image is generated from each plane image according to the relationship between the pixel position of the virtual plane and the pixel position of the projection image that is defined so that the plane image is observed without distortion when observing the screen from a presumed viewing position to generate a right-eye projection image and a left-eye projection image.

Japanese Patent Application No. 2012-080193 filed on Mar. 30, 2012, is hereby incorporated by reference in its entirety.

### BACKGROUND

The present invention relates to a stereoscopic device and an image generation method.

JP-A-2003-85586 discloses a technique that projects an image with a small amount of distortion onto a curved screen.

### SUMMARY

According to one aspect of the invention, there is provided a stereoscopic device that allows a user to observe a stereoscopic image by observing an image projected onto a curved screen from a presumed viewing position, the stereoscopic device comprising:

a virtual camera setting section that sets a right virtual camera and a left virtual camera in a virtual three-dimensional space;

a virtual plane setting section that sets a plurality of virtual planes in front of the right virtual camera and the left virtual camera in a line-of-sight direction;

a virtual plane image generation section that generates a virtual plane image that corresponds to the right virtual camera and a virtual plane image that corresponds to the left virtual camera by perspective projection transformation of the virtual three-dimensional space onto the plurality of virtual planes; and

a projection image generation section that generates a projection image that is projected onto the curved screen using a pixel position correspondence relationship and the virtual plane images, the pixel position correspondence relationship defining a relationship between a pixel position of the plurality of virtual planes and a pixel position of the projection image so that the virtual plane images are observed without distortion when the user observes the curved screen from the presumed viewing position.

According to another aspect of the invention, there is provided an image generation method that generates a projection image that can be observed as a stereoscopic image when a user observes the projection image projected onto a curved screen from a presumed viewing position, the method comprising:

setting a right virtual camera and a left virtual camera in a virtual three-dimensional space;

setting a plurality of virtual planes in front of the right virtual camera and the left virtual camera in a line-of-sight direction;

generating a virtual plane image that corresponds to the right virtual camera and a virtual plane image that corresponds to the left virtual camera by perspective projection transformation of the virtual three-dimensional space onto the plurality of virtual planes; and

generating the projection image using a pixel position correspondence relationship and the virtual plane images, the pixel position correspondence relationship defining a relationship between a pixel position of the plurality of virtual planes and a pixel position of the projection image so that the virtual plane images are observed without distortion when the user observes the curved screen from the presumed viewing position.

### BRIEF DESCRIPTION OF THE DRAWINGS

FIG. 1 illustrates a configuration example of a game system.

FIG. 2 illustrates a configuration example of a game system.

FIG. 3 is a view illustrating a virtual viewpoint setting method.

FIGS. 4A and 4B are views illustrating a virtual plane setting method.

FIG. 5 is a view illustrating perspective projection transformation.

FIG. 6 is a view illustrating perspective projection transformation.

FIG. 7 is a view illustrating a problem that may occur when using two virtual viewpoints.

FIG. 8 is a view illustrating a screen common to two virtual viewpoints.

FIG. 9 is a view illustrating the coordinate system of a screen common to two virtual viewpoints.

FIGS. 10A and 10B are views illustrating two virtual viewpoints that are set to face perpendicularly to a common screen.

FIG. 11 is a view illustrating a target pixel of a projection image.

FIG. 12 is a view illustrating the characteristics of an fθ lens.

FIGS. 13A and 13B are views illustrating a light ray emitted from a target pixel of a projection image.

FIG. 14 is a view illustrating a method that calculates the intersection point of a light ray emitted from a target pixel and the plane of projection.

FIG. 15 is a view illustrating a method that calculates the intersection point of the line of sight of a virtual viewpoint and a virtual plane.

FIG. 16 is a view illustrating generation of a projection image based on a pixel position correspondence map.

FIGS. 17A and 17B are views illustrating a pixel position relationship utilizing the vertex coordinates of a polygon.

FIGS. 18A and 18B are views illustrating a pixel position relationship utilizing the vertex coordinates of a polygon.

FIG. 19 is a functional configuration diagram of a game system.

FIG. 20 is a flowchart illustrating a game process.

FIG. 21 illustrates another virtual plane setting example.

FIGS. 22A and 22B illustrate another virtual plane setting example.

### DESCRIPTION OF EXEMPLARY EMBODIMENTS

Several embodiments of the invention may implement a stereoscopic device that projects an image onto a curved screen.

According to one embodiment of the invention, there is provided a stereoscopic device that allows a user to observe a stereoscopic image by observing an image projected onto a curved screen from a presumed viewing position, the stereoscopic device comprising:

a virtual camera setting section that sets a right virtual camera and a left virtual camera in a virtual three-dimensional space;

a virtual plane setting section that sets a plurality of virtual planes in front of the right virtual camera and the left virtual camera in a line-of-sight direction;

a virtual plane image generation section that generates a virtual plane image that corresponds to the right virtual camera and a virtual plane image that corresponds to the left virtual camera by perspective projection transformation of the virtual three-dimensional space onto the plurality of virtual planes; and

a projection image generation section that generates a projection image that is projected onto the curved screen using a pixel position correspondence relationship and the virtual plane images, the pixel position correspondence relationship defining a relationship between a pixel position of the plurality of virtual planes and a pixel position of the projection image so that the virtual plane images are observed without distortion when the user observes the curved screen from the presumed viewing position.

According to another embodiment of the invention, there is provided an image generation method that generates a projection image that can be observed as a stereoscopic image when a user observes the projection image projected onto a curved screen from a presumed viewing position, the method comprising:

setting a right virtual camera and a left virtual camera in a virtual three-dimensional space;

setting a plurality of virtual planes in front of the right virtual camera and the left virtual camera in a line-of-sight direction;

generating a virtual plane image that corresponds to the right virtual camera and a virtual plane image that corresponds to the left virtual camera by perspective projection transformation of the virtual three-dimensional space onto the plurality of virtual planes; and

generating the projection image using a pixel position correspondence relationship and the virtual plane images, the pixel position correspondence relationship defining a relationship between a pixel position of the plurality of virtual planes and a pixel position of the projection image so that the virtual plane images are observed without distortion when the user observes the curved screen from the presumed viewing position.

According to the stereoscopic device and the image generation method, the right virtual camera and the left virtual camera are set in the virtual three-dimensional space, and a plurality of virtual planes are set in the line-of-sight direction of the right virtual camera and the left virtual camera. Note that the range covered by the virtual planes need not necessarily include the entire field of view of the virtual camera. It suffices that the virtual planes cover the range projected onto the curved screen. The virtual plane image that corresponds to the right virtual camera and the virtual plane image that corresponds to the left virtual camera are generated by perspective projection transformation of the virtual three-dimensional space onto the virtual planes. The projection image is generated using the pixel position correspondence relationship and the virtual plane images, the pixel position correspondence relationship defining the relationship between the pixel position of the virtual planes and the pixel position of the projection image so that the virtual plane images are observed without distortion when the user observes the curved screen from the presumed viewing position. The projection image thus generated is projected onto the curved screen, and can be observed as a stereoscopic image when the user observes the curved screen from the presumed viewing position.

When observing a 2D image (non-stereoscopic image) displayed on a curved screen, the curved screen may be recognized as a wall. According to the stereoscopic image obtained by applying the technology according to the embodiment of the invention, it is possible to implement openness as if the wall of the curved screen were removed.

In the stereoscopic device,

the virtual plane image generation section may generate the virtual plane image that corresponds to the right virtual camera and the virtual plane image that corresponds to the left virtual camera by perspective projection transformation using the plurality of virtual planes as a screen common to the right virtual camera and the left virtual camera.

According to the above feature, the perspective projection transformation based on the right virtual camera and the left virtual camera is performed using the virtual planes as a common perspective projection transformation screen. This makes it unnecessary to separately set the perspective projection transformation screen corresponding to each of the right virtual camera and the left virtual camera.

The stereoscopic device may further comprise:

a projection device that projects the projection image so that a center of the projection image coincides with an intersection position of the presumed viewing direction of the user and the curved screen.

According to the above feature, the projection image is projected so that the center of the projection image coincides with the intersection position of the presumed viewing direction of the user and the curved screen. This makes it possible to suppress distortion of the stereoscopic image in the presumed viewing direction as compared with the end of the curved screen, and improve the visibility of the stereoscopic image when the user observes the stereoscopic image.

In the stereoscopic device,

the virtual plane setting section may set two or three virtual planes so that the virtual planes are connected to each other.

According to the above feature, two or three virtual planes are set so that the virtual planes are connected to each other. This makes it possible to minimize an increase in drawing load that may occur when performing the stereoscopic image drawing calculation process since it suffices to provide only two or three virtual planes.

In the stereoscopic device,

the virtual plane setting section may change a connection angle of the virtual planes.

According to the above feature, the connection angle of the virtual planes can be changed.

In the stereoscopic device,

the virtual plane setting section gradually may change a position of the virtual planes so that a relative angle with respect to the virtual camera gradually changes.

According to the above feature, the position of the virtual planes can be gradually changed so that the relative angle with respect to the virtual camera gradually changes.

The stereoscopic device according to the embodiment of the invention utilizes two or three virtual planes as a substitute (approximation) to the curved screen in order to reduce the drawing load. Therefore, the curved screen and the virtual planes are matched via partial scaling (e.g., Mercator projection that projects the globe onto a cylinder). If the connection angle of the virtual planes and the relative angle with respect to the virtual camera are fixed, the degree of scaling differs partially, but does not change. On the other hand, an accurately calculated parallax image is required in order to implement a stereoscopic image. Therefore, an area that can be relatively easily observed as a stereoscopic image, and an area that is difficult to observe as a stereoscopic image may be present on the curved screen depending on the degree of scaling.

In order to deal with such a situation, the relationship between the curved screen and the virtual plane is changed by changing the connection angle of the virtual planes or the relative angle with respect to the virtual camera to adjust the degree of scaling. This makes it possible to generate an appropriate projection image so that an area of the curved screen that is desired to be observed as a stereoscopic image can be easily observed as a stereoscopic image.

The stereoscopic device may further comprise:

an attention point setting section that sets an attention point that moves in the virtual three-dimensional space,

the virtual plane setting section changing the position of the virtual planes corresponding to a position of the attention point.

According to the above feature, the position of the virtual planes is changed corresponding to the position of the attention point in the virtual three-dimensional space. Therefore, the image at the attention point can be relatively easily observed as a stereoscopic image.

Exemplary embodiments of the invention are described below with reference to the drawings. Note that the embodiments to which the invention can be applied are not limited to the following exemplary embodiments.

### Configuration of Game Device

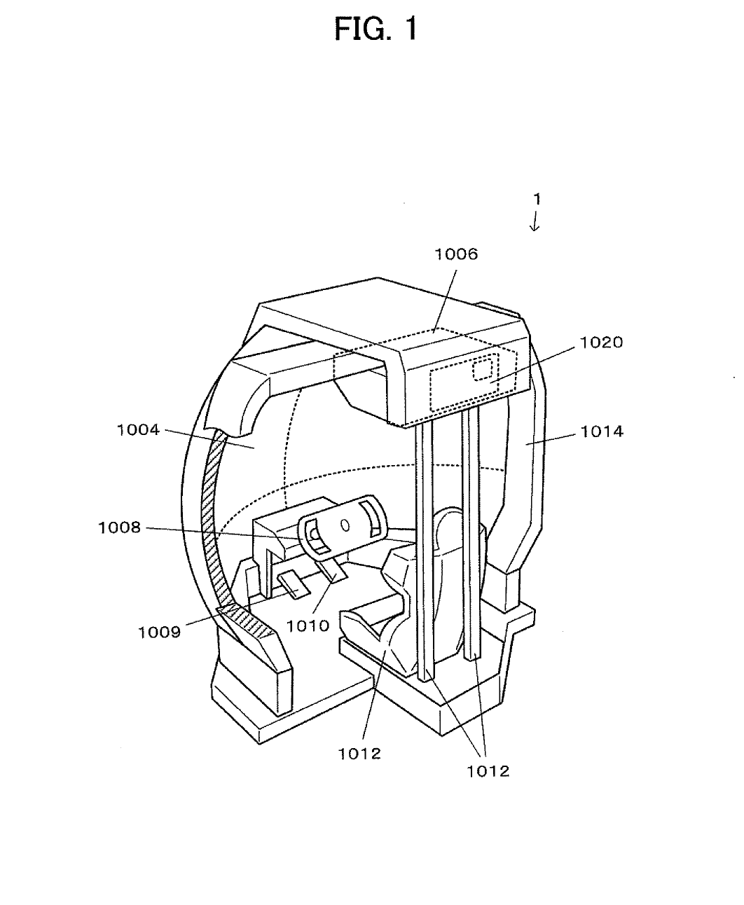

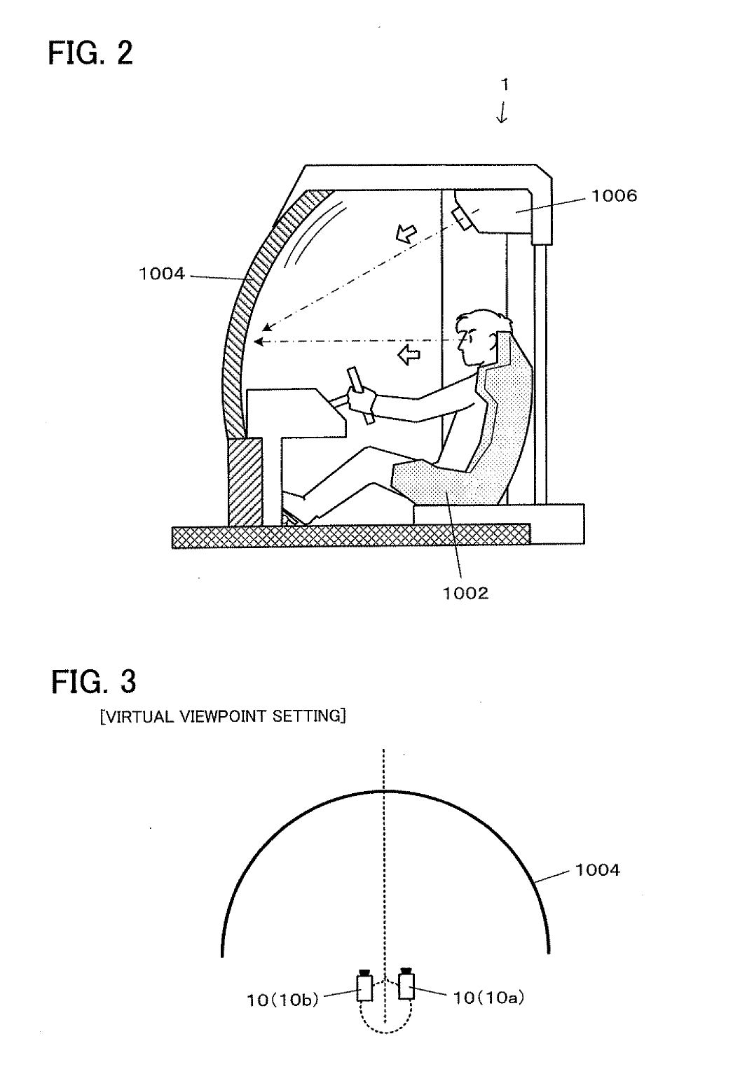

FIG. 1 illustrates a configuration example of a game system 1 to which a stereoscopic device according to one embodiment of the invention is applied. FIG. 2 is a vertical cross-sectional view illustrating the game system 1. The game system 1 is an arcade game system that is installed in a store or the like, and implements or executes a car racing game. The game system 1 includes a player's seat 1002 that imitates the driver's seat of a racing car, a curved screen 1004 that displays a game screen (image), a projector 1006 that projects an image onto the screen 1004, a speaker (not illustrated in the drawings) that outputs a game sound, a steering wheel 1008, a shift lever, an accelerator pedal 1010, a brake pedal 1009 that allow the player to input a game operation, and a control board 1020.

The direction and the height of the player's seat 1002 are adjusted so that the center area of the screen 1004 is present in a presumed viewing direction of the player who sits on the player's seat 1002. In one embodiment of the invention, the presumed viewing direction is the front direction of the player who sits on the player's seat 1002. The curved screen 1004 is formed to be convex in the front direction (presumed viewing direction) of the player who sits on the player's seat 1002.

The projector 1006 that is a projection device is supported by a housing frame 1014 and posts 1012 that are provided behind the player's seat 1002, and is disposed at a position above the player's seat 1002 at which the projector 1006 does not interfere with the player who sits on the player's seat 1002 so that the center area of the screen 1004 is present in the direction from the projection center of the projector 1006. Specifically, the projector 1006 is disposed so that the direction from the projection center intersects (faces) the intersection position of the presumed viewing direction of the player and the curved screen. A wide-angle lens is attached to the projector 1006 as a projection lens. A projection image is projected onto the entire plane of projection of the screen 1004 through the wide-angle lens.

The control board 1020 includes a microprocessor (e.g., CPU, GPU, and DSP), an ASIC, and an IC memory (e.g., VRAM, RAM, and ROM). The control board 1020 performs various processes for implementing the car racing game based on a program and data stored in the IC memory, and operation signals input from the steering wheel 1008, the accelerator pedal 1010, the brake pedal 1009, and the like.

The player sits on the player's seat 1002, and plays the car racing game by operating the steering wheel 1006, the accelerator pedal 1010, and the brake pedal 1009 while observing the game screen displayed on the screen 1004, and hearing the game sound output from the speaker.

The car racing game according to one embodiment of the invention is designed so that a background object (e.g., racetrack) is disposed in a virtual three-dimensional space to form a game space. Various objects such as a player's car operated by the player and a player's car operated by another player are disposed in the game space. A virtual viewpoint (virtual camera) is also disposed in the game space at the position of the driver of the player's car. The projector 1006 projects (displays) an image (stereoscopic image) of the game space based on the virtual viewpoint onto (on) the screen 1004 as the game image.

### Stereoscopic Image Generation Principle

In one embodiment of the invention, a right-eye stereoscopic image and a left-eye stereoscopic image are alternately displayed by time division so that the player can observe a stereoscopic image. The player wears stereoscopic glasses (not illustrated in the drawings) that utilize a film-type patterned retarder technique, a time-division technique (e.g., liquid crystal shutter technique), or a spectroscopic technique, and observes the image displayed on (projected onto) the screen 1004 as a stereoscopic image.

In one embodiment of the invention, the virtual three-dimensional space (game space) and the real space have a 1:1 scaling relationship. Note that the scaling relationship between the virtual three-dimensional space (game space) and the real space may be arbitrarily set depending on the game. For example, when the game is designed so that a small player character (e.g., insect) travels around the game world, the scaling relationship between the virtual three-dimensional space (game space) and the real space may be set to 1:25.

The stereoscopic image generation principle according to one embodiment of the invention is described below. A presumed position of each eye of the player (viewer) in a state in which the player sits on the player's seat 1002 is referred to as “presumed viewing position”. A virtual viewpoint 10 (right-eye virtual viewpoint 10a and left-eye virtual viewpoint 10b) is disposed in the virtual three-dimensional space (game space) at a position corresponding to the presumed viewing position (see FIG. 3). In FIG. 3, the virtual three-dimensional space is identical with the real space since the virtual three-dimensional space and the real space have a 1:1 scaling relationship. Note that the following description and the drawings illustrate an example in which the coordinates of the virtual three-dimensional space are identical with the coordinates of the real space for convenience of explanation.

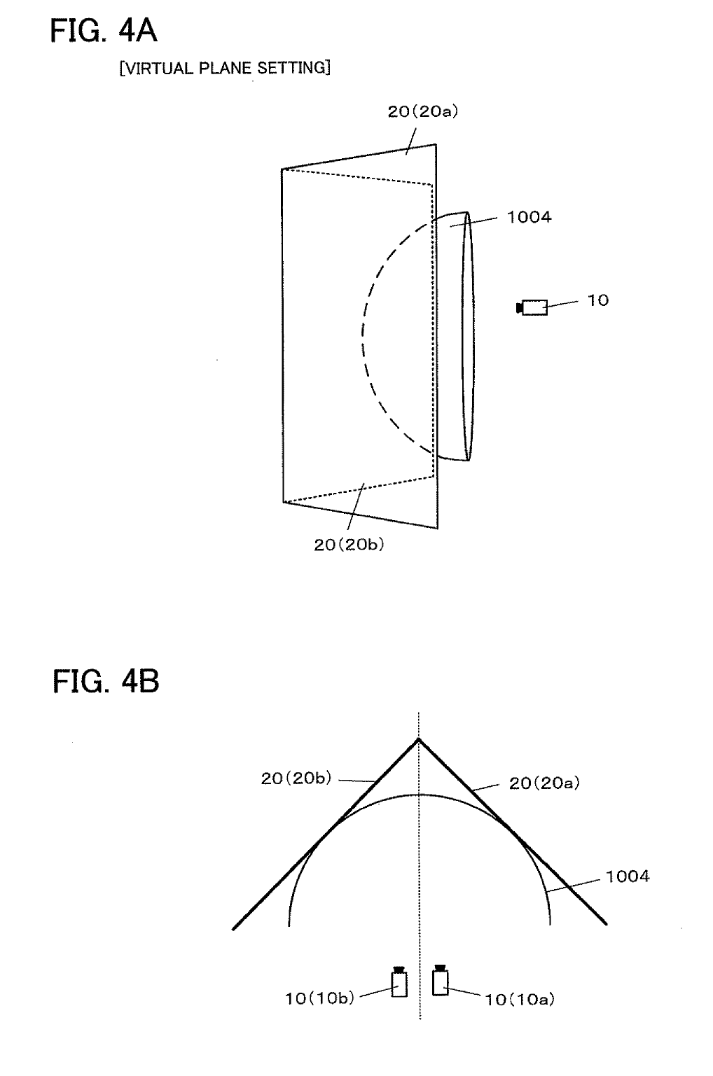

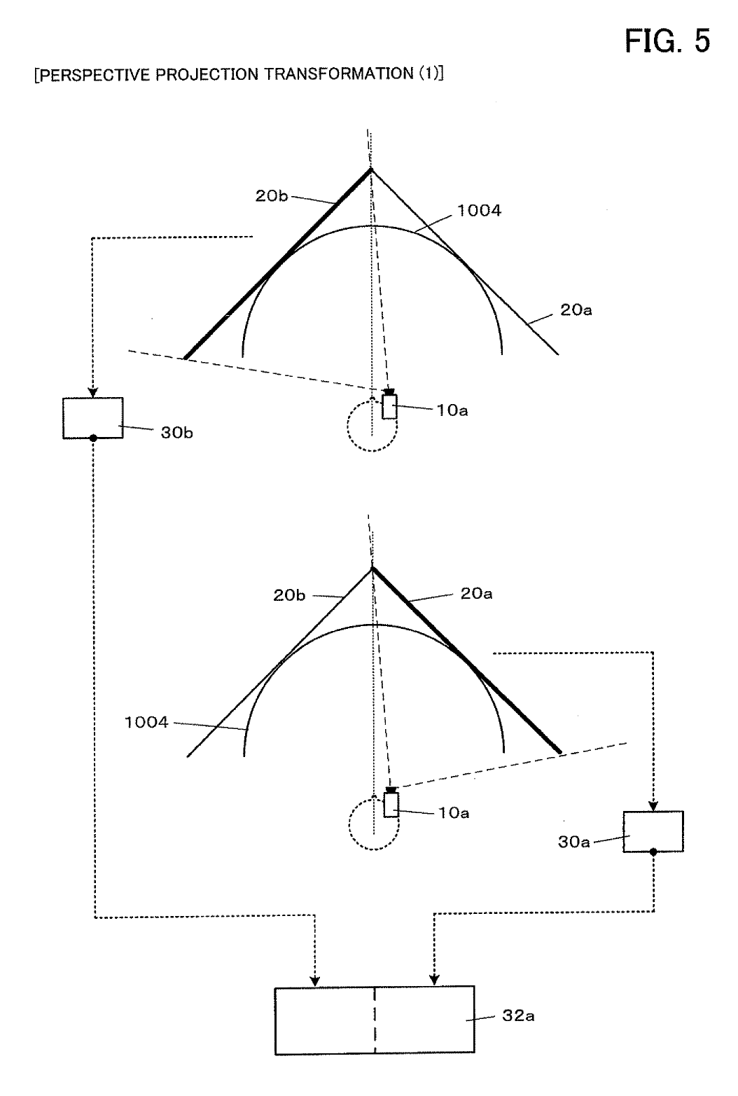

As illustrated in FIGS. 4A and 4B, two virtual planes 20a and 20b are set in the virtual three-dimensional space. The virtual planes 20a and 20b simulate the plane of projection of the screen 1004, and are sized and positioned to cover the field of view (i.e., include or cover the range of the field of view) of the virtual viewpoint 10. More specifically, the virtual planes 20a and 20b are positioned so that the virtual planes 20a and 20b are vertical to each other, and are circumscribed to the screen (plane of projection) 1004. The virtual planes 20a and 20b are set so that the virtual planes 20a and 20b are arranged side by side and connected at an angle of 90° to face the virtual viewpoint 10, and the connection line between the virtual planes 20a and 20b is present in the presumed viewing direction when viewed from the virtual viewpoint 10.

Note that the range covered by the virtual planes 20a and 20b need not necessarily include the entire field of view of the virtual viewpoint 10. It suffices that the virtual planes 20a and 20b cover a range that corresponds to the range displayed on (projected onto) the screen 1004.

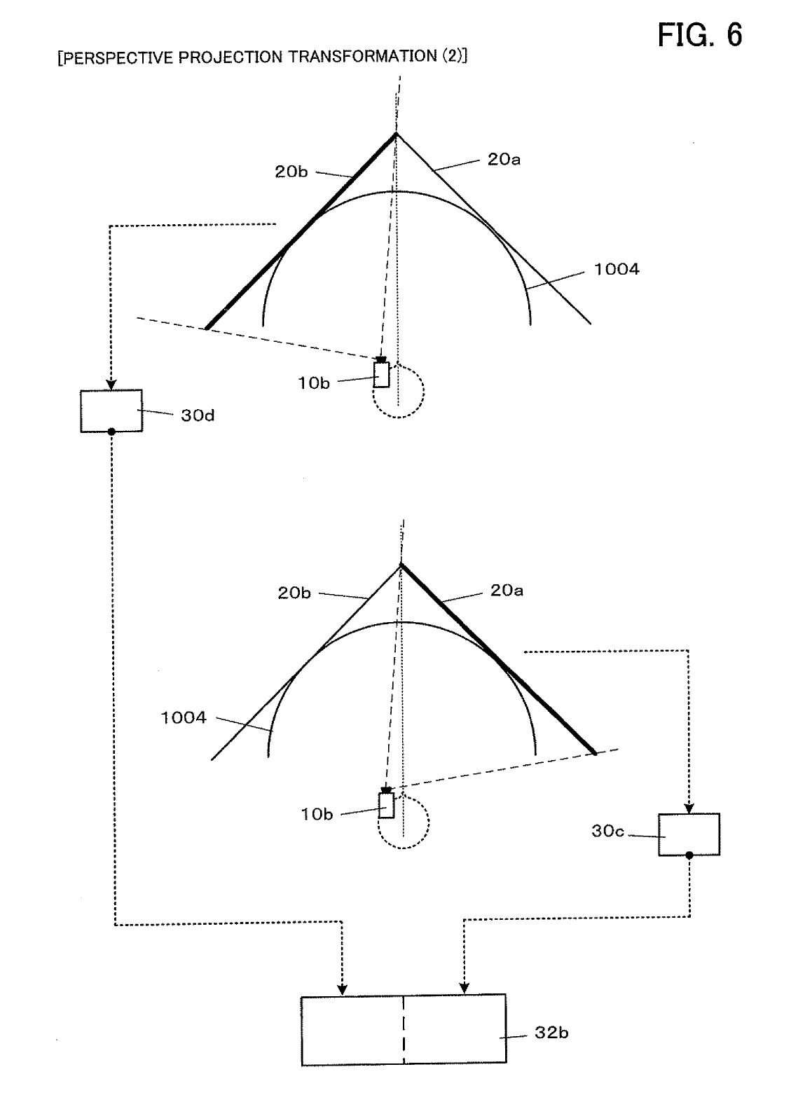

When the virtual planes 20a and 20b have been set as described above, a plane image 32 is generated by utilizing the virtual planes 20a and 20b as a perspective projection transformation screen. More specifically, the plane image 32 is generated by perspective projection transformation of the virtual three-dimensional space onto the virtual plane 20 based on the virtual viewpoint 10 (see FIGS. 5 and 6). Note that a right-eye plane image 32a based on the right-eye virtual viewpoint 10 and a left-eye plane image 32b based on the left-eye virtual viewpoint 10b are generated in order to generate a stereoscopic image.

As illustrated in FIG. 5, a plane image 30a obtained by perspective projection transformation of the virtual three-dimensional space onto the virtual plane 20a, and a plane image 30b obtained by perspective projection transformation of the virtual three-dimensional space onto the virtual plane 20b, are generated based on the right-eye virtual viewpoint 10a. The plane images 30a and 30b are combined to generate the right-eye plane image 32a that regards the virtual planes 20a and 20b as a single plane.

As illustrated in FIG. 6, the left-eye plane image 32b is generated by perspective projection transformation of the virtual three-dimensional space onto the virtual planes 20a and 20b based on the left-eye virtual viewpoint 10h.

The reason why the virtual planes 20a and 20b are commonly used as the perspective projection transformation virtual screen for the right-eye virtual viewpoint 10a and the left-eye virtual viewpoint 10b is described below. Specifically, since an image drawn in the virtual plane is corrected to fit the screen 1004, the virtual screen need not necessarily be common to the right-eye virtual viewpoint 10a and the left-eye virtual viewpoint 10b. However, since a drawing program can be simplified, and it is easy to intuitively determine the drawing state as a result of using the virtual screen common to the right-eye virtual viewpoint 10a and the left-eye virtual viewpoint 10b, an adjustment and debugging are facilitated.

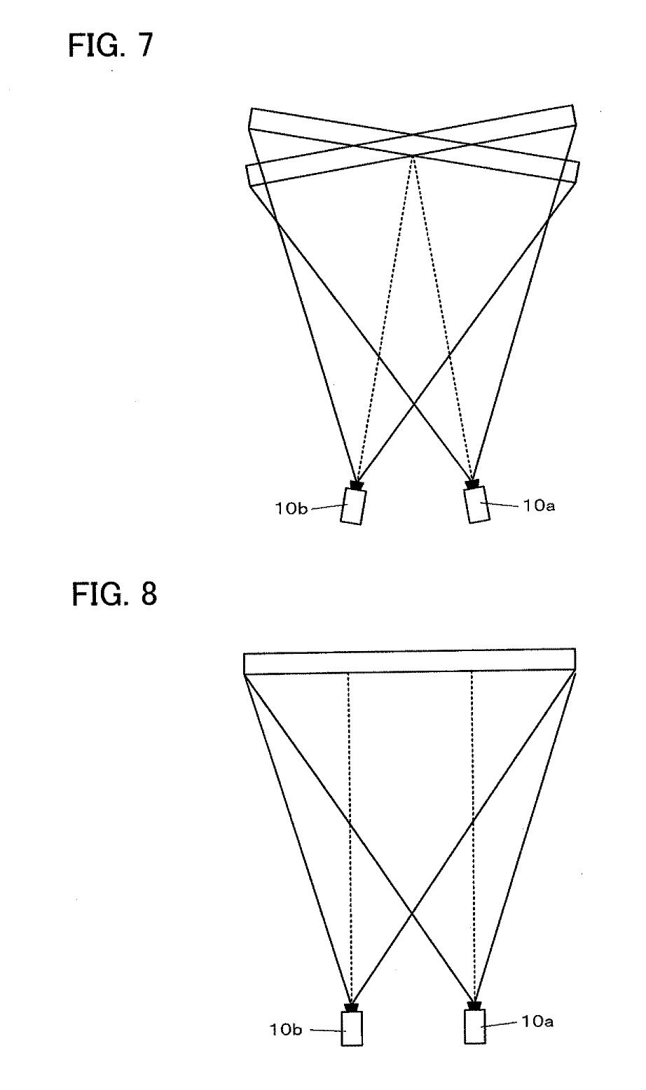

A perspective projection transformation process for generating a two-dimensional mage is normally designed so that the virtual screen is orthogonal to the line-of-sight direction, and the intersection point of the virtual screen and the line-of-sight direction coincides with the center of the rectangular virtual screen by setting the line-of-sight direction, the vertical angle of view, and the horizontal angle of view. However, when applying such a method to the right-eye virtual viewpoint 10a and the left-eye virtual viewpoint 10b, vertical parallax due to keystone (trapezoidal) distortion occurs since the virtual screen differs between the right-eye virtual viewpoint 10a and the left-eye virtual viewpoint 10b (see FIG. 7).

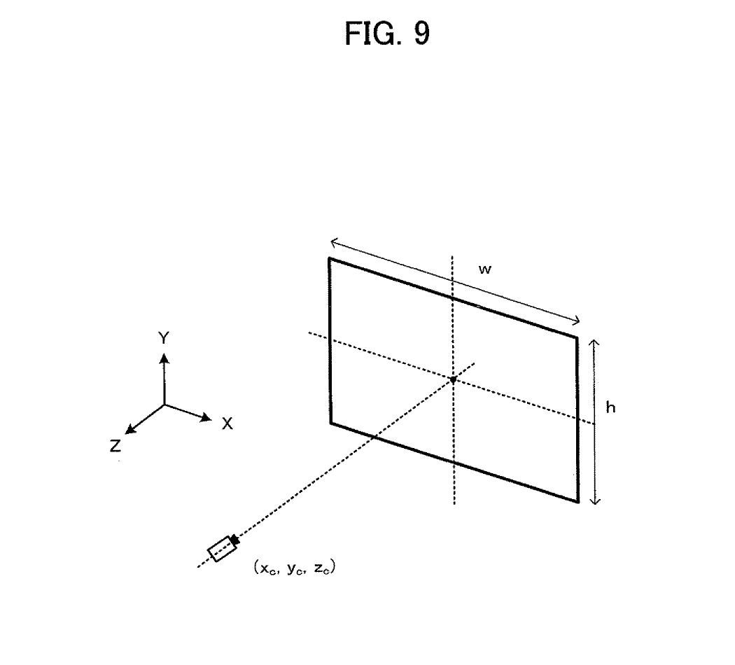

Such a situation can be avoided by setting a virtual screen common to the right-eye virtual viewpoint 10a and the left-eye virtual viewpoint 10b (see FIG. 8). For example, the projection matrix represented by the following expression (1) may be used when generating the view frustum. Since the element (3, 1) and the element (3, 2) are not zero (0), it is possible to set a skewed transformation matrix in which the foot of a perpendicular line drawn from the viewpoint to the virtual screen is shifted from the center of the virtual screen. Note that α and β in the expression (1) are determined by the Z-positions of the front clipping plane and the back clipping plane before and after transformation.

$$( x , y , z , 1 ) ( \begin{matrix}\frac{2 {z}_{c}}{w} & 0 & 0 & 0 \\ 0 & \frac{2 {z}_{c}}{h} & 0 & 0 \\ - \frac{2 {x}_{c}}{w} & - \frac{2 {x}_{c}}{w} & α & - 1 \\ 0 & 0 & β & 0\end{matrix} ) \qquad ( 1 )$$

where, w is the width (horizontal dimension) of the common screen, h is the height (vertical dimension) of the common screen, (x, y, z) is the screen coordinates when the center of the common screen is the origin, and (x_{c}, y_{c}, z_{c}) is the position coordinates of the virtual viewpoint when the center of the common screen is the origin (see FIG. 9). Note that the horizontal direction with respect to the common screen is referred to as “x-axis direction”, the vertical direction with respect to the common screen is referred to as “y-axis direction”, and the depth direction with respect to the common screen is referred to as “z-axis direction”. Therefore, z_{c} is the distance between the common screen and the virtual viewpoint.

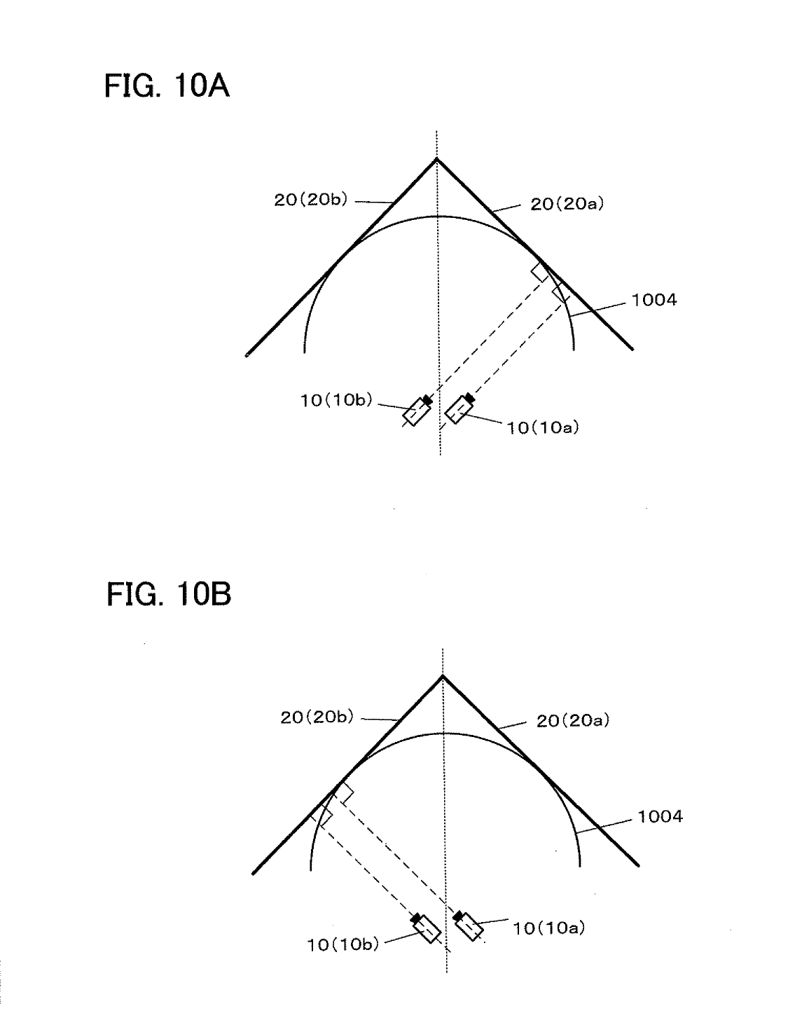

A versatile CG drawing system such as OpenGL (registered trademark) or DirectX (registered trademark) utilizes the direction of the virtual viewpoint (virtual camera) in order to determine the direction (normal) of the virtual screen. It is necessary to set the right-eye virtual viewpoint 10a and the left-eye virtual viewpoint 10b to perpendicularly face the virtual plane 20a (see FIG. 10A), and then set the skew component. Likewise, it is necessary to set the right-eye virtual viewpoint 10a and the left-eye virtual viewpoint 10b to perpendicularly face the virtual plane 20b (see FIG. 10B), and then set the skew component.

When the virtual screen has thus been determined, it suffices to take account of only the position of the right-eye virtual viewpoint 10a and the position of the left-eye virtual viewpoint 10b. The following description illustrates an example in which the right-eye virtual viewpoint 10a and the left-eye virtual viewpoint 10b face front for convenience of explanation.

The plane image 32 (32a and 32b) is generated by perspective projection transformation of the virtual three-dimensional space onto the virtual plane 20. When the plane image 32 is projected directly onto the curved screen (plane of projection) 1004, the resulting image is distorted. The amount of distortion is relatively small in the vicinity of the contact position of the virtual plane 20 and the screen (plane of projection) 1004, and increases as the distance from the contact position increases.

In order to correct the distortion, a coordinate transformation process is performed on the plane image to generate a projection image 40. More specifically, the relationship (correspondence relationship) between the position of the projection image 40 and the projection position in the virtual plane 20 (i.e., the position of the plane image 32) is calculated, and the projection image 40 is generated using the calculated relationship and the plane image 32. The above relationship may be calculated for the right-eye plane image 32a based on the right-eye virtual viewpoint 10a and the left-eye plane image 32b based on the left-eye virtual viewpoint 10h using an identical method.

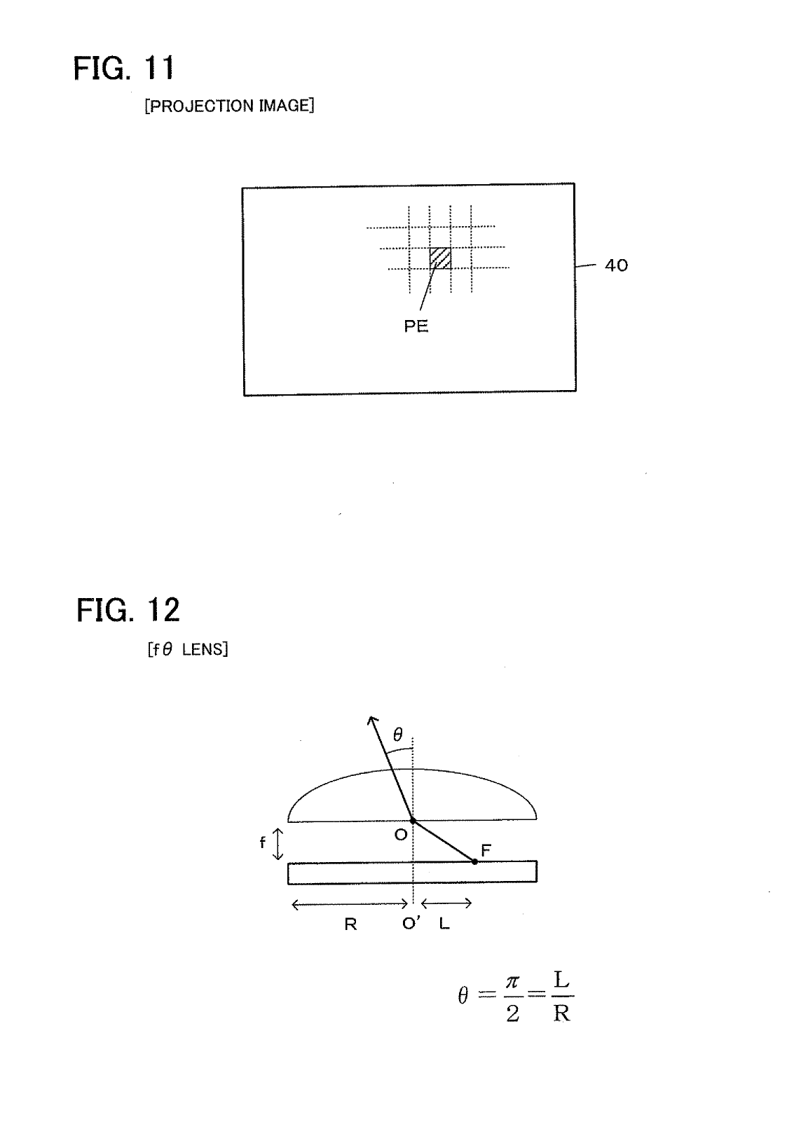

FIG. 11 illustrates an example of the projection image 40. As illustrated in FIG. 11, a pixel among the pixels that form the projection image 40 is referred to as “target pixel PE”. A light ray emitted from the target pixel PE when the projector 1006 projects the projection image 40 through the wide-angle lens is calculated. In one embodiment of the invention, an fθ lens is used as the wide-angle lens. FIG. 12 is a view illustrating the characteristics of the fθ lens. As illustrated in FIG. 12, the fθ lens is characterized in that the emission angle θ of a light ray that passes through the center O of the fθ lens from a position F is proportional to the distance L from the center O of the fθ lens.

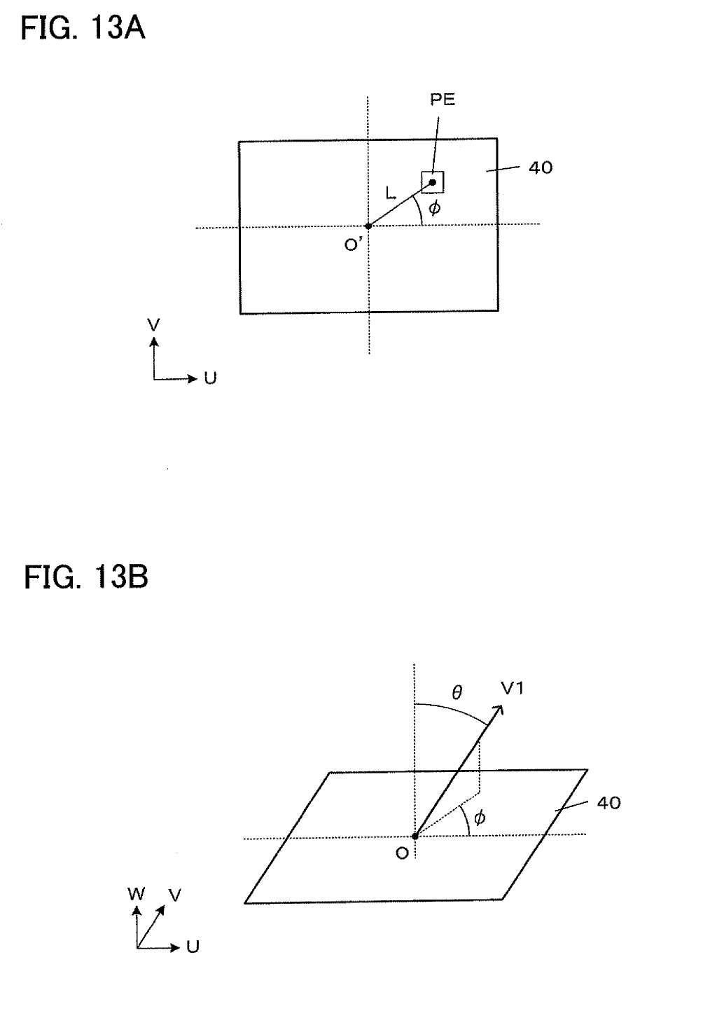

FIGS. 13A and 13B are views illustrating a method that calculates a light ray emitted from the target pixel. When the direction from the projection center of the projector 1006 is the direction that passes through the center O of the projection lens (fθ lens), and the center O′ of the projection image 40 is positioned in the direction from the projection center, a light ray V1 is emitted from the target pixel PE in the direction at an emission angle θ with respect to the direction vertical to the projection image 40 (i.e., the direction from the projection center of the projector 1006), the emission angle θ being proportional to the distance L from the center O′ of the projection image 40 to the target pixel PE.

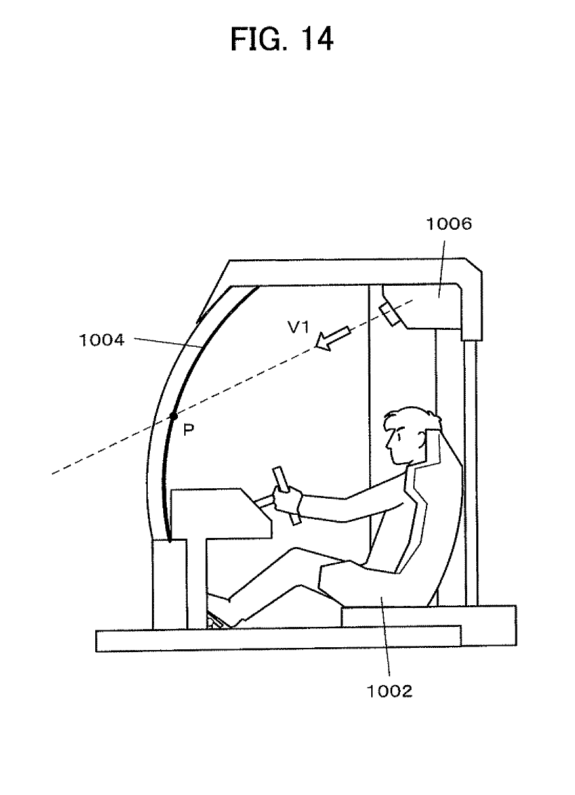

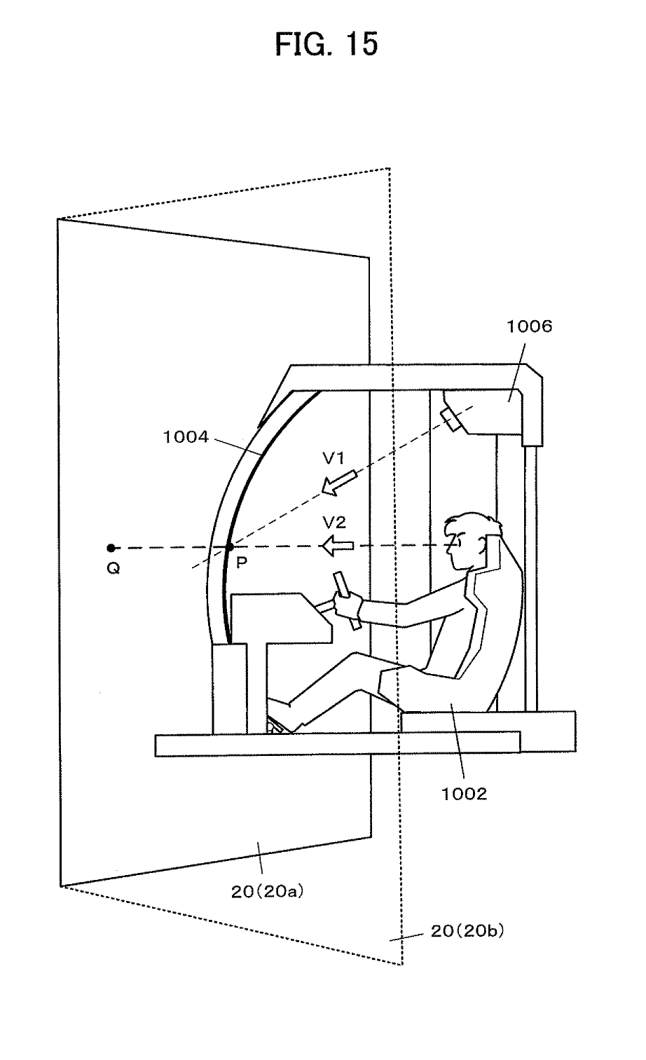

As illustrated in FIG. 14, the intersection point P of the light ray V1 emitted from the target pixel PE and the screen (plane of projection) 1004 is calculated. As illustrated in FIG. 15, a line of sight V2 from the virtual viewpoint 10 that intersects the intersection point P is calculated. The position of the virtual viewpoint 10 corresponds to the presumed viewing position (see FIG. 15). The intersection point Q of the line of sight V2 and the virtual plane 20 is then calculated. The intersection point Q is the position in the virtual plane 20 (i.e., the position of the plane image 32) that corresponds to the target pixel PE of the projection image 40.

The position in the virtual plane 20 that corresponds to each pixel of the projection image 40 is calculated in the same manner as described above. A stereoscopic image without distortion can be implemented by setting the color of each pixel of the projection image 40 to be the color at the corresponding pixel position of the plane image 32.

The relationship between the pixel position of the projection image 40 and the pixel position of the plane image 32 thus calculated is referred to as “pixel position correspondence map 50”. A right-eye pixel position correspondence map 50a that corresponds to the right-eye virtual viewpoint 10a, and a left-eye pixel position correspondence map 50b that corresponds to the left-eye virtual viewpoint 10h are generated as the pixel position correspondence map 50.

When the drawing environment including the positions of the right eye and the left eye, the virtual plane, and the screen shape is symmetrical, the left-eye pixel position correspondence map 50b is obtained by reversing the right-eye pixel position correspondence map 50a. In this case, since it suffices to provide one pixel position correspondence map 50, it is possible to save the pixel position correspondence map calculation time and the memory capacity for storing the pixel position correspondence map 50.

Since the pixel position correspondence map 50 is fixed when the size and the position of the virtual plane 20 do not change, and the positions of the right eye and the left eye of the viewer do not change to a large extent, the pixel position correspondence map 50 may be generated in advance before generating an image, or may be generated when generating an image.

When the pixel position correspondence map 50 is generated when generating an image, the process can be performed at a sufficiently high speed, and the positions of the right eye and the left eye of the viewer can be accurately and quickly detected by head tracking or eye tracking, it is possible to deal with a situation in which the viewer has moved his head, and display a more natural stereoscopic image by generating the pixel position correspondence map 50 based on the positions of the right-eye virtual viewpoint 10a and the left-eye virtual viewpoint 10b in real time.

Even if the process cannot be performed in real time, it is possible to generate a stereoscopic image that is more appropriate for the viewer by acquiring the positions of the right eye and the left eye of the viewer during the initial setting process, and generating the pixel position correspondence map 50 corresponding to the positions of the right eye and the left eye of the viewer.

It is also possible to implement an effective effect in which the space appears to gradually extend as compared with a dome screen image (i.e., an image that is stuck to the wall of a dome) by setting the positions of the right-eye virtual viewpoint 10a and the left-eye virtual viewpoint 10b at the center between the right eye and the left eye so that the right-eye virtual viewpoint 10a and the left-eye virtual viewpoint 10b gradually move to the positions of the left eye and the right eye, respectively, and applying the corresponding pixel position correspondence map 50. Note that the pixel position correspondence map 50 may be generated in advance corresponding to the positions of the virtual viewpoints 10a and 10b, or may be generated at a high speed during the process.

When the projection image 40 (i.e., the projection image that corresponds to the right-eye virtual viewpoint and the projection image that corresponds to the left-eye virtual viewpoint) has been generated using the plane image 32 (32a and 32b) and the pixel position correspondence map 50 (50a and 50b), the projection image 40 is projected from the projector 1006.

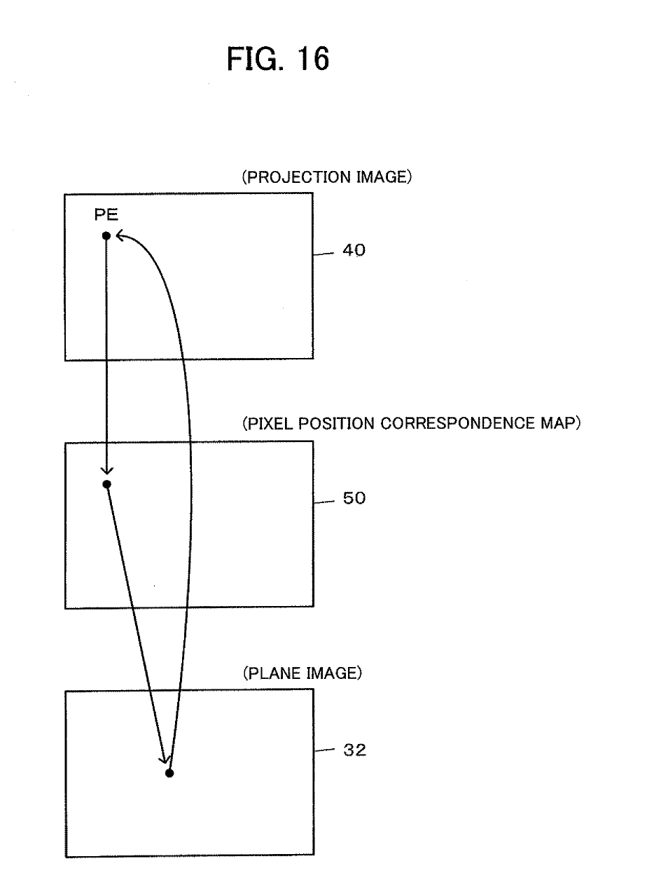

The projection image 40 is thus generated by the above stereoscopic image generation principle. It is reasonable to generate the projection image 40 as described below instead of generating the plane image 32 in advance. As illustrated in FIG. 16, the pixel of the plane image 32 that corresponds to each pixel of the projection image 40 is calculated from the pixel position correspondence map 50. The color information about each pixel of the plane image 32 is calculated, and used as the color information about each pixel of the projection image 40. The above process is performed on each pixel of the projection image 40 to determine the color information about the projection image 40. When the plane image 32 is larger than the projection image 40, the drawing load can be reduced by utilizing the above drawing process.

When using the above drawing process, since the pixel position correspondence map 50 is generated corresponding to each pixel of the projection image 40, it is necessary to provide a map having a size corresponding to the number of pixels of the projection image 40. Therefore, it may be difficult to store such a large map in the memory depending on the hardware conditions. Moreover, it takes time to calculate the map.

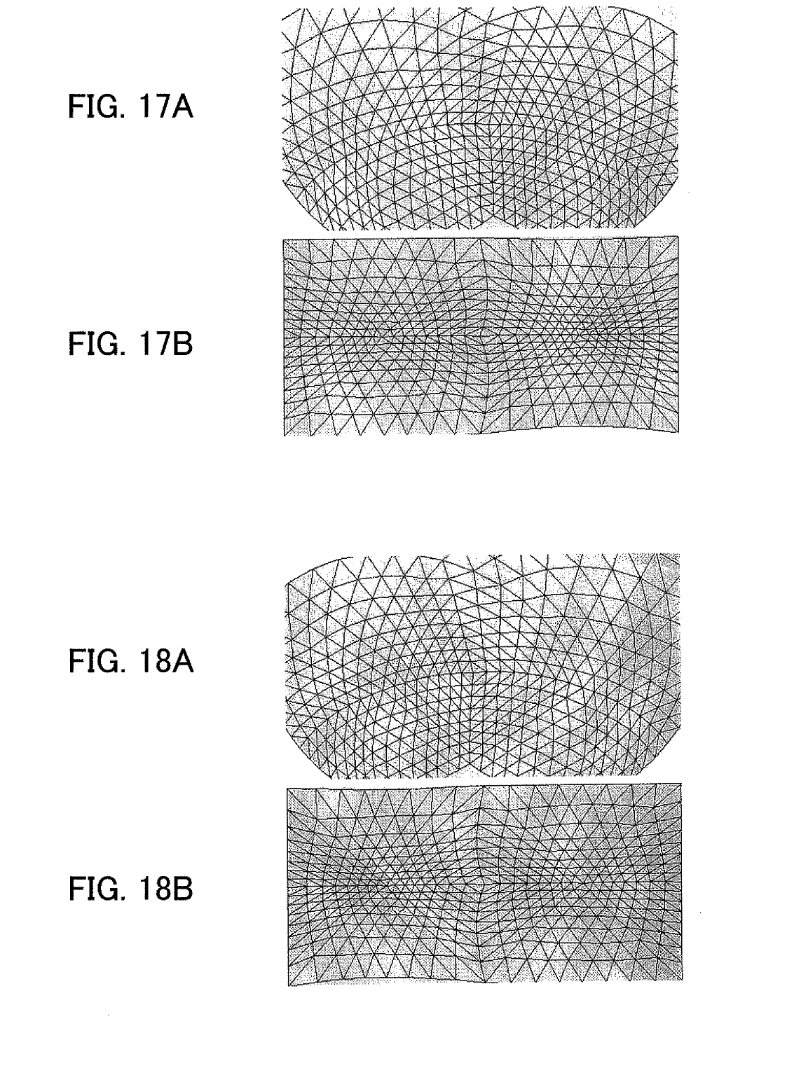

The above problems may be solved by utilizing the vertex coordinates of a polygon. The details of the method that utilizes the vertex coordinates of a polygon are described below. As illustrated in FIGS. 17B and 18B, the plane image 32 is divided in a mesh-like pattern. Note that the mesh-like pattern illustrated in FIGS. 17B and 18B is only an example, and another mesh-like pattern may also be used. The position (X, Y) of the projection image 40 that corresponds to the vertex coordinates (U, V) of the polygon of each mesh (each triangle in FIGS. 17A to 18B) is calculated, and the coordinates (X, Y) of the projection image 40 and the coordinates (U, V) of the plane image 32 are stored as coordinate relationship data corresponding to each vertex of each polygon. The projection image 40 is generated by referring to the position (U, V) of the plane image 32 that corresponds to the vertex coordinates (X, Y) of the polygon that forms each mesh of the projection image 40 that is determined by the coordinate relationship data.

FIGS. 17A and 17B illustrate an image viewed from the right-eye virtual viewpoint 20a, and FIGS. 18A and 18B illustrate an image viewed from the left-eye virtual viewpoint 20b. FIGS. 17A and 18A illustrate the projection image 40 that is divided in a mesh-like pattern, and FIGS. 17B and 18B illustrate the plane image 32 that is divided in a mesh-like pattern.

In this case, a normal textured polygon drawing process implemented by a GPU may be used. Specifically, the texture coordinates (U, V) of each vertex of each polygon are referred to, and the polygon drawing process is performed so that the pixel value of the plane image 32 is acquired based on the coordinates (U, V) obtained by interpolating the coordinate value of each vertex. This makes it possible to store the pixel position relationship using a significantly small memory capacity as compared with the case of storing a map that corresponds to the number of pixels of the projection image 40. Moreover, since the amount of calculations is reduced, the coordinate position relationship data can be generated at a higher speed.

Since the above method utilizes the interpolation process, the accuracy may decrease as compared with the case of providing a map (pixel position correspondence map 50) that corresponds to the number of pixels of the projection image 40. However, since the number of meshes can be arbitrarily increased or decreased, the coordinate relationship data can be appropriately generated while giving priority to the accuracy of the image or the memory capacity/calculation time.

### Functional Configuration

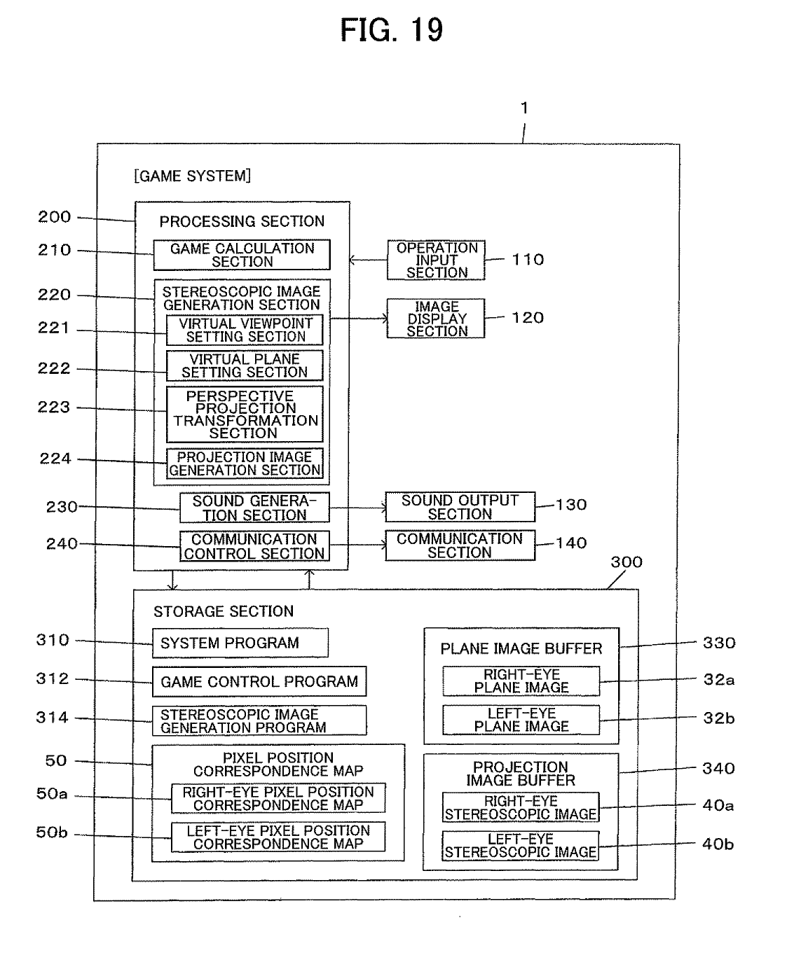

FIG. 19 is a block diagram illustrating the functional configuration of the game system 1 according to one embodiment of the invention. As illustrated in FIG. 19, the game system 1 functionally includes an operation input section 110, an image display section 120, a sound output section 130, a communication section 140, a processing section 200, and a storage section 300.

The operation input section 110 allows the player to input an operation instruction, and outputs an operation signal that corresponds to the operation instruction to the processing section 200. The function of the operation input section 110 is implemented by a button switch, a lever, a mouse, a keyboard, a sensor, and the like. In FIG. 1, the steering wheel 1008, the accelerator pedal 1010, and the brake pedal 1009 correspond to the operation input section 110.

The processing section 200 controls the entire game system 1, and performs various calculation processes (e.g., game process and image generation process) based on a program and data read from the storage section 300, the operation signal input from the operation input section 110, and the like. The processing section 200 includes a game calculation section 210 that mainly performs a game execution calculation process, a stereoscopic image generation section 220, a sound generation section 230, and a communication control section 240.

The game calculation section 210 controls the car racing game by performing a process in accordance with a game control program 312 based on a game operation performed by the player using the operation input section 110, and the like.

The stereoscopic image generation section 220 includes a virtual viewpoint setting section 221, a virtual plane setting section 222, a perspective projection transformation section 223, and a projection image generation section 224, and generates a stereoscopic image displayed on the image display section 120 based on the results of calculations performed by the game calculation section 210. More specifically, the stereoscopic image generation section 220 generates a right-eye stereoscopic image based on the right-eye virtual viewpoint 10a and a left-eye stereoscopic image based on the left-eye virtual viewpoint 10b at a given image generation timing (e.g., at intervals of 1/120th of a second), and outputs image signals of the generated images to the image display section 120. The function of the stereoscopic image generation section 220 is implemented by a processor (e.g., digital signal processor (DSP)), a control program, a drawing frame IC memory (e.g., frame buffer), and the like.

The virtual viewpoint setting section 221 sets the virtual viewpoint 10 (right-eye virtual viewpoint 10a and left-eye virtual viewpoint 10b) that corresponds to each eye of the player (viewer) in the game space.

The virtual plane setting section 222 sets the virtual planes 20a and 20b in the game space in accordance with the above principle.

The perspective projection transformation section 223 generates the plane image 32 by perspective projection transformation of the game space onto the virtual plane 20 based on the virtual viewpoint 10. More specifically, the perspective projection transformation section 223 generates the plane images 30a and 30b by perspective projection transformation of the game space onto the virtual planes 20a and 20b based on the right-eye virtual viewpoint 10a. The perspective projection transformation section 223 combines the plane images 30a and 30b to generate the right-eye plane image 32a (see FIG. 5). Likewise, the perspective projection transformation section 223 generates the plane images 30c and 30d by perspective projection transformation of the game space onto the virtual planes 20a and 20b based on the left-eye virtual viewpoint 10b, and combines the plane images 30e and 30d to generate the left-eye plane image 32b.

The plane image 32 thus generated is stored in a plane image buffer 330. The plane image buffer 330 includes a storage area for the right-eye plane image 32a and a storage area for the left-eye plane image 32b.

The projection image generation section 224 generates the projection image that corresponds to the right-eye virtual viewpoint and the projection image that corresponds to the left-eye virtual viewpoint using the plane image 32 generated by the perspective projection transformation section 223 and the pixel position correspondence map 50. The projection image thus generated is displayed on the display section 120 as a stereoscopic image. More specifically, the projection image generation section 224 generates the right-eye projection image by setting the color information about the corresponding pixel of the right-eye plane image 32a to each pixel of the right-eye projection image referring to a right-eye pixel position correspondence map 321. Likewise, the projection image generation section 224 generates the left-eye projection image by setting the color information about the corresponding pixel of the left-eye plane image 32b to each pixel of the left-eye projection image referring to a left-eye pixel position correspondence map 322.

The projection image thus generated is stored in a projection image buffer 340. The projection image buffer 340 includes a storage area for the right-eye projection image and a storage area for the left-eye projection image.

The image display section 120 is a curved display that alternately displays the right-eye stereoscopic image and the left-eye stereoscopic image by time division based on the image signal input from the stereoscopic image generation section 220. The function of the image display section 120 is implemented by a combination of the curved screen 1004 and the projector 1006 illustrated in FIG. 1, for example.

The sound generation section 230 generates a game sound (e.g., effect sound and background music (BGM)) used during the game, and outputs a sound signal of the generated game sound to the sound output section 130. The sound output section 130 outputs the game sound (e.g., effect sound and background music (BGM)) based on the sound signal input from the sound generation section 230. The function of the sound output section 130 is implemented by a speaker or the like.

The storage section 300 stores a system program that implements a function that causes the processing section 200 to integrally control the game system, a program and data necessary for causing the processing section 200 to execute the game, and the like. The storage section 300 is used as a work area for the processing section 200, and temporarily stores the results of calculations performed by the processing section 200 according to various programs, data input from the operation input section 110, and the like. The function of the storage section 300 is implemented by a storage device such as an IC memory, a hard disk, a CD-ROM, a DVD, an MO, a RAM, or a VRAM. In FIG. 1, the IC memory included in the control board 1020 corresponds to the storage section 300, for example. In one embodiment of the invention, the storage section 300 stores a system program 310, a game control program 312, a stereoscopic image generation program 314, and the pixel position correspondence map 50, and includes the plane image buffer 330 and the projection image buffer 340.

### Process Flow

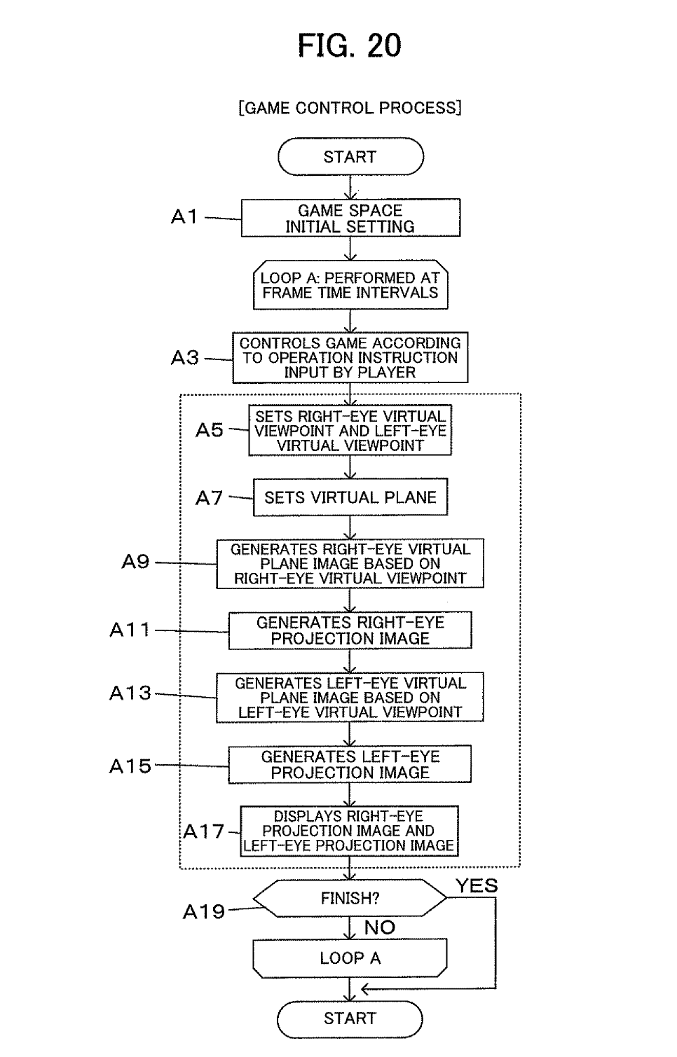

FIG. 20 is a flowchart illustrating the flow of a game process. In a step A1, the game calculation section 210 performs a game space initial setting process. The game calculation section 210 then repeatedly performs a loop A process at given frame time intervals.

In the loop A process, the game calculation section 210 controls the game according to an operation instruction input by the player using the operation input section 110 (step A3). The stereoscopic image generation section 220 then generate a stereoscopic image.

Specifically, the virtual viewpoint setting section 221 sets the virtual viewpoint 10 (right-eye virtual viewpoint 10a and left-eye virtual viewpoint 10b) in the game space (step A5). The virtual plane setting section 222 sets the virtual planes 20a and 20b in the game space (step A7).

The perspective projection transformation section 223 then generates the right-eye plane image 32a by perspective projection transformation of the game space onto the virtual planes 20a and 20b based on the right-eye virtual viewpoint 10a (step A9). The projection image generation section 224 generates the right-eye projection image 40a based on the right-eye plane image 32a referring to the right-eye pixel position correspondence map 50a (step A11). The perspective projection transformation section 223 generates the left-eye plane image 32b by perspective projection transformation of the game space onto the virtual planes 20a and 20b based on the left-eye virtual viewpoint 10b (step A13). The projection image generation section 224 generates the left-eye projection image 40b based on the left-eye plane image 32b referring to the left-eye pixel position correspondence map 50b (step A15).

The right-eye projection image 40a and the left-eye projection image 40b are displayed on the image display section 120 (step A17). The game calculation section 210 then determines whether or not to terminate the game. When the game calculation section 210 has determined to terminate the game (step A19: YES), the game calculation section 210 terminates the loop A process to complete the game process.

### Advantageous Effects

According to one embodiment of the invention, the right-eye and left-eye virtual viewpoints 10 (10a and 10b) are set in the virtual three-dimensional space (game space), and a plurality of virtual planes 20a and 20b that cover at least the range of the field of view of each virtual viewpoint 10 are set in the line-of-sight direction of each virtual viewpoint 10. The plane images 32a and 32b are generated by perspective projection transformation of the virtual three-dimensional space onto the virtual planes 20a and 20b based on the virtual viewpoint 10. The projection image 40 is generated using the pixel position correspondence map 50 and the plane images 32a and 32b, the pixel position correspondence map 50 defining the relationship between the pixel position of the virtual planes 20a and 20b and the pixel position of the projection image 40 so that the plane images 32a and 32b are observed without distortion when observing the screen 1004 from the presumed viewing position. The projection image 40 thus generated is projected onto the curved screen 1004 through the wide-angle lens, and can be observed as a stereoscopic image when observing the screen 1004 from the presumed viewing position.

The following advantageous effect is obtained as a secondary effect. Specifically, when observing a 2D image (non-stereoscopic image) displayed on a curved screen, the curved screen may be recognized as a wall. According to the stereoscopic image obtained by applying the technology according to one embodiment of the invention, it is possible to implement openness as if the wall of the curved screen were removed.

According to one embodiment of the invention, the screen 1004 is formed to be convex in the presumed viewing direction of the player who sits on the player's seat 1002, and the projector 1006 is disposed so that the direction from the projection center of the projector 1006 intersects the intersection position of the presumed viewing direction and the screen 1004. This makes it possible to suppress distortion of the stereoscopic image in the presumed viewing direction as compared with the end of the screen 1004, and improve the visibility of the stereoscopic image when the player who sits on the player's seat 1002 observes the stereoscopic image.

The virtual planes 20a and 20b are connected in the horizontal direction, and are set to face the virtual viewpoint 10. This makes it possible to minimize an increase in drawing load that may occur when performing the drawing calculation process on the stereoscopic image that is displayed on a dome screen.

### Modifications

The embodiments to which the invention can be applied are not limited to the above embodiments. Various modifications and variations may be appropriately made without departing from the scope of the invention.

### (A) Virtual Plane Setting

The above embodiments have been described taking an example in which the relative positional relationship between the virtual planes 20a and 20b and the screen 1004 is fixed. Note that the relative positional relationship between the virtual planes 20a and 20b and the screen 1004 may be set variably.

The virtual planes 20a and 20b are set as a plane that approximates the plane of projection of the curved screen 1004. Therefore, the curved screen 1004 and the virtual planes 20a and 20b are matched via partial scaling (e.g., Mercator projection that projects the globe onto a cylinder). On the other hand, an accurately calculated parallax image is required in order to implement a stereoscopic image. Therefore, an area that can be easily observed as a stereoscopic image, and an area that is difficult to observe as a stereoscopic image may be present on the screen (plane of projection) 1004 depending on the degree of scaling. In the example illustrated in FIGS. 4A and 4B, the vicinity of the contact position of the plane of projection 1004 and the virtual plane 20a or 20b can be most easily observed since the amount of distortion is relatively small, and the visibility tends to decrease as the distance from the contact position increases.

A position to which it is desired that the player pay attention, and a position to which the player tends to pay attention differ depending on the game situation. For example, when the game is a racing game, the player may pay attention in the front direction when the player's car travels on a straight level road, and may pay attention to an upper position in the front direction when the player's car travels on a straight uphill road. The player may pay attention to a position on the right side of the front direction when the player's car travels on a right-hand curve since the player turns his eyes to a position ahead of the curve. Therefore, the virtual planes 20a and 20b (i.e., the relative positional relationship between the virtual planes 20a and 20b and the screen (plane of projection) 1004) may be set so that the attention point that may change depending on the game situation coincides with the contact position of the virtual plane 20a or 20b and the screen (plane of projection) 1004.

For example, the connection angle of the virtual planes 20a and 20b may be set variably. The connection angle may be gradually decreased when the attention point moves toward the right end or the left end of the screen 1004. In this case, the contact position is shifted toward the right end or the left end of the screen 1004. The connection angle may be gradually increased when the attention point moves toward the center of the screen 1004. In this case, the contact position is shifted toward the center of the screen 1004. Note that it is necessary to change the size of the virtual planes 20a and 20b along with a change in the connection angle. This is because the virtual planes 20a and 20b must largely cover the field of view of the virtual viewpoint 10.

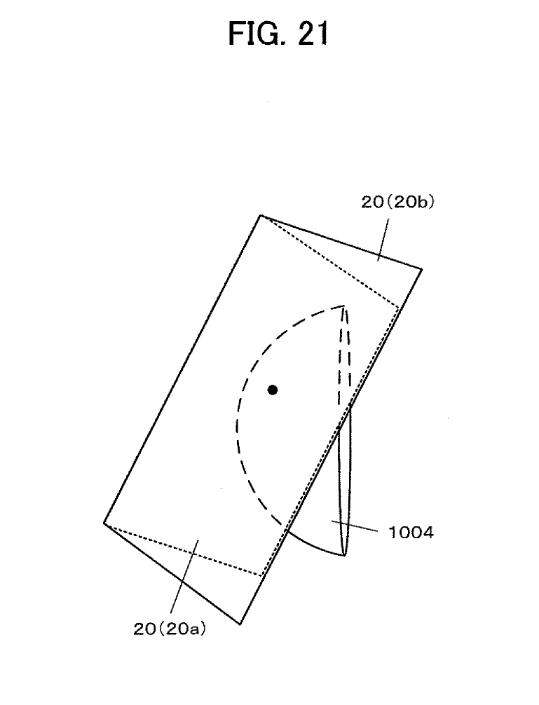

As illustrated in FIG. 21, the relative angle of the virtual planes 20a and 20b with respect to the virtual viewpoint 10 may be changed without changing the connection angle. Specifically, when the attention point moves upward when viewed from the virtual viewpoint 10, the relative angle of the virtual planes 20a and 20b may be changed in the upward direction with respect to the virtual viewpoint 10 (see FIG. 21). In this case, the contact position is shifted toward the upper side of the screen 1004. The contact position is shifted toward the lower side of the screen 1004 when the attention point moves downward when viewed from the virtual viewpoint 10.

Note that it is also possible to change both the connection angle and the relative angle of the virtual planes 20a and 20b with respect to the virtual viewpoint 10.

### (B) Number of Virtual Planes

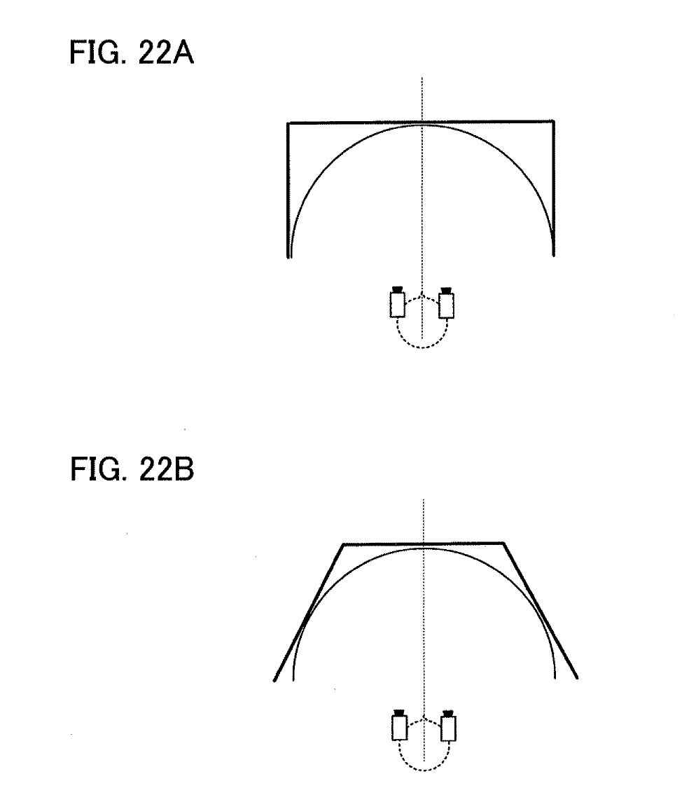

The above embodiments have been described taking an example in which two virtual planes 20a and 20b are provided. Note that an arbitrary number of virtual planes may be set. For example, three virtual planes 20 may be connected in the shape of the character “C” when viewed from above (see FIG. 22A), or may be connected to have a trapezoidal shape when viewed from above (see FIG. 22B), instead of connecting two virtual planes 20 in the shape of the character “V” when viewed from above (see FIG. 4B).

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A stereoscopic device that allows a user to observe a stereoscopic image by observing an image projected onto a curved screen from a presumed viewing position, the stereoscopic device comprising:
a virtual camera setting section that sets a right virtual camera and a left virtual camera in a virtual three-dimensional space;
a virtual plane setting section that sets a plurality of virtual planes in front of the right virtual camera and the left virtual camera in a line-of-sight direction;
a virtual plane image generation section that generates a virtual plane image that corresponds to the right virtual camera and a virtual plane image that corresponds to the left virtual camera by perspective projection transformation of the virtual three-dimensional space onto the plurality of virtual planes; and
a projection image generation section that generates a projection image that is projected onto the curved screen using a pixel position correspondence relationship and the virtual plane images, the pixel position correspondence relationship defining a relationship between a pixel position of the plurality of virtual planes and a pixel position of the projection image so that the virtual plane images are observed without distortion when the user observes the curved screen from the presumed viewing position.

2. The stereoscopic device as defined in claim 1,
the virtual plane image generation section generating the virtual plane image that corresponds to the right virtual camera and the virtual plane image that corresponds to the left virtual camera by perspective projection transformation using the plurality of virtual planes as a screen common to the right virtual camera and the left virtual camera.

3. The stereoscopic device as defined in claim 1, further comprising:
a projection device that projects the projection image so that a center of the projection image coincides with an intersection position of the presumed viewing direction of the user and the curved screen.

4. The stereoscopic device as defined in claim 1,
the virtual plane setting section setting two or three virtual planes so that the virtual planes are connected to each other.

5. The stereoscopic device as defined in claim 4,
the virtual plane setting section changing a connection angle of the virtual planes.

6. The stereoscopic device as defined in claim 4,
the virtual plane setting section gradually changing a position of the virtual planes so that a relative angle with respect to the virtual camera gradually changes.

7. The stereoscopic device as defined in claim 6, further comprising:
an attention point setting section that sets an attention point that moves in the virtual three-dimensional space,
the virtual plane setting section changing the position of the virtual planes corresponding to a position of the attention point.

8. An image generation method that generates a projection image that can be observed as a stereoscopic image when a user observes the projection image projected onto a curved screen from a presumed viewing position, the method comprising:
setting a right virtual camera and a left virtual camera in a virtual three-dimensional space;
setting a plurality of virtual planes in front of the right virtual camera and the left virtual camera in a line-of-sight direction;
generating a virtual plane image that corresponds to the right virtual camera and a virtual plane image that corresponds to the left virtual camera by perspective projection transformation of the virtual three-dimensional space onto the plurality of virtual planes; and
generating the projection image using a pixel position correspondence relationship and the virtual plane images, the pixel position correspondence relationship defining a relationship between a pixel position of the plurality of virtual planes and a pixel position of the projection image so that the virtual plane images are observed without distortion when the user observes the curved screen from the presumed viewing position.
